(19) United States
(12) Patent Application Publication
(10) Pub. No.: US 2019/0318426 A1
(43) Pub. Date: Oct. 17, 2019

(54) VEHICLE FUEL AS A SERVICE

(71) Applicant: ATIONET LLC, Miami, FL (US)

(72) Inventors: Gaston FAVEREAU, Buenos Aires (AR); Pablo C. GUALDI, Mexico D.F. (MX)

(21) Appl. No.: 16/386,165

(22) Filed: Apr. 16, 2019

Related U.S. Application Data
(60) Provisional application No. 62/658,321, filed on Apr. 16, 2018.

(51) Int. Cl. G06Q 40/04; G06F 16/903; G06Q 20/02; G06Q 50/06

(52) U.S. Cl. CPC G06Q 40/04; G06Q 50/06; G06Q 20/023; G06F 16/903

(57) ABSTRACT

Multiple fuel suppliers and fuel demand consumers provide profile information to an accounts/profile database. Oil suppliers associated with one or more fuel suppliers also provide profile information to the accounts/profile database. Fuel suppliers upload supply posts and demand consumers upload demand posts and a fuel clearinghouse services fulfill demand posts with supply posts based on preferences and restrictions, including contractual restrictions based on the profiles in the accounts/profile database. Upon fulfillment, payment is effected, contracts, such as purchase orders are automatically generated, and usage is monitored until a fulfilled supply post is exhausted. Post, preference, and usage data are centralized and subject to analytics including machine learning analytics, and reports are displayed on portals.

### CROSS-REFERENCE TO RELATED PATENT APPLICATION

This application claims priority to U.S. Provisional Patent Application No. 62/658,321, filed on Apr. 16, 2018, entitled “Vehicle Fuel Distribution Usage Cases,” which is hereby incorporated by reference in its entirety.

### BACKGROUND

Typical consumers think of vehicle fuel management simply as an issue of taking their personal vehicle to their local gas station and purchasing fuel whenever they are running low. Since the amount of fuel for their personal vehicle is relatively small compared to the amount of gasoline generally in stock at a typical gas station, availability of gasoline on demand is generally not an issue. In the unlikely event the nearest gas station is out of gas or otherwise non-operational, generally there are nearby gas stations proximate enough not to cause an undue inconvenience. Accordingly, for individual consumers, little, if any, provision need be made to manage availability of gasoline at a time and location of their choice.

This is not the case for large consumers of vehicle fuel. Companies that operate fleets of vehicles that may range in wide geographical locations have fuel demands that are large enough and complex enough as to impact the operation of gas stations. Examples of such companies, called fuel demand consumers, or demand consumers for short, include trucking companies, bus companies, and other mass and bulk transportation companies operating fleets of road vehicles. Demand consumers not only consume large amounts of fuel, but will consume that fuel over a constantly shifting set of locations that change over time.

Fuel providers, generally in the form of a gas station operator, then have the challenges in stocking fuel. If insufficient fuel is stocked, then not only do the demand consumers risk running out of fuel, but also the fuel provider will not realize profit in supplying fuel to the demand consumer. If too much fuel is stocked, then not only do the fuel providers bear the expense of holding fuel inventory, but in some cases, such as with ethanol and agrofuels, the fuel providers bear the risk of spoliation and expiry of fuel. Where the fuel provider operates a number of gas stations, this risk is accordingly multiplied several times over.

Presently, some fuel providers work with oil companies that issue fuel cards. Fuel cards are physical cards storing a code that when swiped in a kiosk at participating gas stations, may be redeemed fully, or in part, for a prepaid amount of fuel. In this business model, called a hierarchical model, fuel cards are issued by an oil company, the fuel cards are only redeemable by gas stations branded by that oil company. Accordingly, fuel cards, and the quantities of fuel demand they represent, are not exchangeable across fuel providers affiliated with different oil companies. Furthermore, fuel cards require specialized hardware to be installed at the gas station to enable redemption. Even if a gas station is affiliated with an oil company that issues fuel cards, only if the gas station has gone to the expense of installing the specialized hardware may the fuel cards be used.

Rather than tying up fuel demand in fuel cards specific to a single oil company, and requiring specialized hardware, there is an unmet need to virtualize vehicle supply and demand, via a platform that provides vehicle fuel as a software service.

### BRIEF DESCRIPTION OF THE DRAWINGS

The Detailed Description is set forth with reference to the accompanying figures.

FIG. 1 is a top-level context diagram for vehicle fuel as a service.

FIG. 2 is a block diagram of an example architecture for vehicle fuel as a service.

FIG. 3 is a block diagram of vehicle fuel as a service.

FIG. 4 is a flow chart for posting and fulfilling supply and demand posts via vehicle fuel as a service.

FIG. 5 is a flow chart for tracking consumed fuel for a supply post and fulfilled demand of a demand post via vehicle fuel as a service.

FIG. 6 is a flow chart of an example process for a fuel clearinghouse service to assist a demand consumer in obtaining fuel from a fuel provider through bidding by multiple fuel providers.

FIG. 7 is a flow chart of an example process for a fuel clearinghouse service to assist a fuel provider in selling fuel inventory to a fuel purchaser or another fuel provider.

FIG. 8 is a flow chart of an example process for a fuel clearinghouse service to assist a fuel provider in selling excess demand for fuel to another fuel provider.

FIG. 9 is a flow chart of an example process for fuel clearinghouse service to validate the redemption of issues fuel codes by a demand consumer for fuel at a fuel provider.

### DETAILED DESCRIPTION

### Context of Vehicle Fuel as a Service

The concept of vehicle fuel as a service virtualizes both fuel supply and fuel demand. Quantities of fuel can be matched to demand consumers. The quantity of fuel may be associated with a specific location, such a specific gas station, and may be associated with a specific time window. The resulting contracts then can themselves be exchanged among fuel providers and other demand consumers. Accordingly, rather than operating within a hierarchical model, supply and demand can be exchanged on a peer-to-peer, cooperative basis.

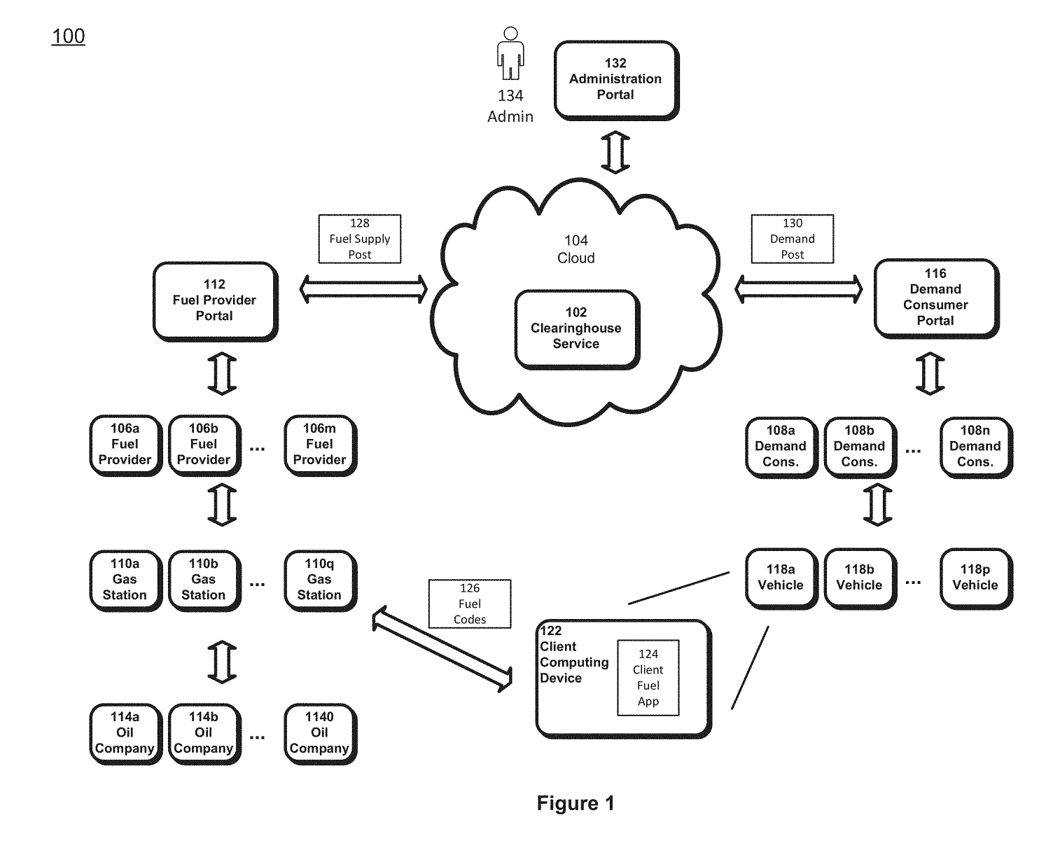

The exchanges may be performed via bidding, reverse auction, or simple postings for sale. Because the fuel is not tied to a specific oil company and because the fuel, demand, and contracts to fulfill demand are all exchangeable, vehicle fuel as a service acts as a universal clearinghouse for fuel supply and demand. As will be described in the use cases in the sections to follow, such a universal clearinghouse for fuel supply and demand enable concepts such as time shifting, fuel shifting, and demand shifting. FIG. 1 is a context diagram 100 for vehicle fuel as a service.

Vehicle fuel as a service is generally implemented as a fuel clearinghouse service 102 on a cloud service 104 or alternatively on a physical server (not shown). The fuel clearinghouse service 102 receives registrations from fuel providers 106a-m and fuel demand consumers 108a-n. The registrations provide the fuel providers 106a-m and the demand consumers 108a-n with accounts by which they can notify other registrants in with the fuel clearinghouse service 102 with fuel supply and fuel demand available for exchange.

Fuel providers 106a-n are generally operators of one or more gas stations 110a-q. Gas stations 110a-q may be geographically disparate, and may operate in multiple countries. In some cases, a group of fuel providers 106a-m may register as a single entity. Fuel providers 106-m generally interface with the fuel clearinghouse service 102 via a fuel provider portal 112. The fuel provider portal 112 may be either a web page or a custom client computing application that provides a fuel provider 106a-m with access to the functionalities in the fuel clearinghouse service 102.

Fuel providers 106a-m are generally affiliated with an oil company 114a-o. The affiliation not only involves the fuel providers 106a-m being branded with the oil company's 114a-o brand, but also gives rise to contractual obligations that the fuel providers 106a-m be resupplied with fuel by the oil company 114a-o that they are affiliated with. Such resupply contracts are known as handling service agreements.

Fuel demand consumers 108a-n represent consumers of relatively large amounts of fuel. Generally, demand consumers 108a-n are transportation companies of cargo, such as trucking companies, or people, such as bus lines. Demand consumers 108a-n interact with the fuel clearinghouse service 102 via a demand consumer portal 116. As with the fuel provider portal 112, the demand consumer portal 116 may be either a web page, or a computer client application by which the demand consumer 108a-n accesses the fuel clearinghouse service 102 functionality.

Fuel demand consumers 108a-n generally operate fleets of vehicles 118a-p. The drivers of the vehicles 118a-p may access fuel from the fuel providers via fuel cards 120. Alternatively, the drivers of the vehicles 118a-p may have a client computing device 122 either on their person as a mobile device or resident in their vehicle 118a-p. The client computing device 122 may have a client fuel application 124 resident in the client computing device 122. The client fuel application 124 enables redemption of fuel codes 126 independent of fuel cards 120.

From a high level, the operation of the fuel clearinghouse service 102 is as follows. A fuel provider 106a-m registers with the fuel clearinghouse service 102, and via the fuel provider portal 112 posts a quantity of fuel as available as a fuel supply post 128. The quantity of fuel may simply be an amount of fuel, and may in fact be represented via a fuel card 120 from an oil company 114a-o. Alternatively, the fuel supply post 128 may specify not only a quantity but a set of locations and a time window expiry.

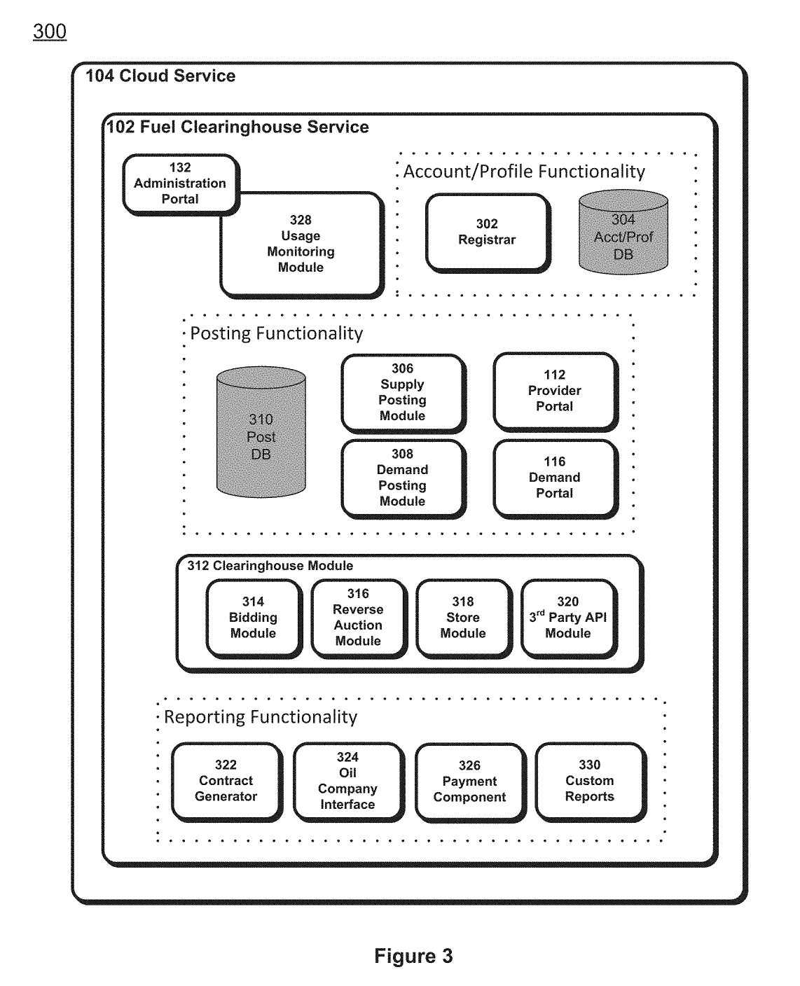

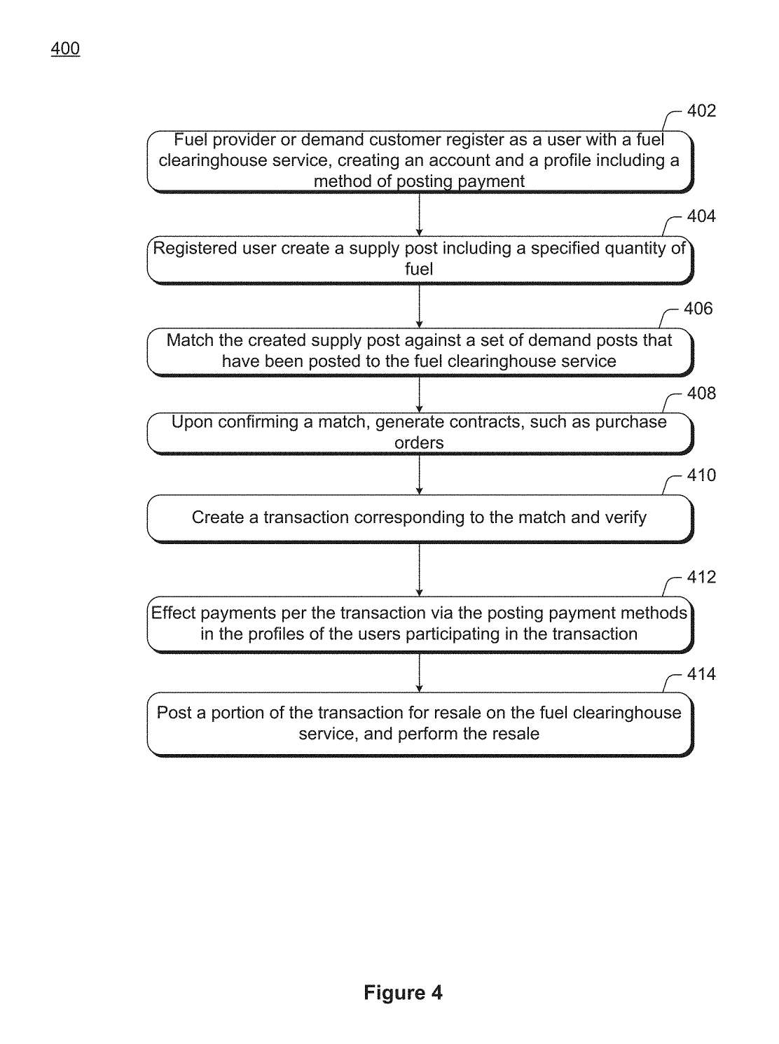

Similarly, a fuel demand consumer 108a-n posts a quantity of fuel representing an amount of fuel required by the demand consumer 108a-n. This posting is called a demand post 130. Upon posting, the fuel clearinghouse service 102 provides various methods for the supply posts 128 and the demand posts 130 to be matched and fulfilled. Those methods include bidding, reverse auction, and posting for sale. These methods to match and to fulfill supply and demand posts 128, 130 are described in further detail with respect to FIGS. 3 and 4.

In one example, a demand consumer 108a-n, say a trucking company, has a number of fuel cards 120 redeemable only in Seattle, but whose trucks are near Chicago. The trucking company can create a supply post 128 for Seattle fuel cards 120 and a demand post 130 for Chicago fuel cards 120. Via the fuel clearinghouse service 102, purchasers for the Seattle fuel cards 120 and sellers of Chicago fuel cards 120 are identified. Ideally, the purchaser and the seller are one and the same. The fuel clearinghouse service 102 effects the exchange contracts, and charges a fee. The fee may be implemented via a payment method associated with the seller and buyer accounts registered with the fuel clearinghouse service 102. The fuel clearinghouse service 102 has an administrative portal 132 where an administrator 134 may monitor transactions, payments, and identify potential disputes between sellers and buyers.

In the previous example, supply and demand were represented with legacy fuel cards. However, the notion of vehicle fuel as a service is to virtualize fuel supply and demand. Rather than exchanging fuel cards 120, supply and demand may be exchanged as supply and demand posts 128, 130, and fuel may be redeemed via fuel codes 126 made available to fleet vehicles 118a-p via a client fuel application 124 running on a client computing device 122. Scenarios and use cases for virtualized supply and demand are described in further detail in later sections.

### Exemplary Environment for Vehicle Fuel as a Service

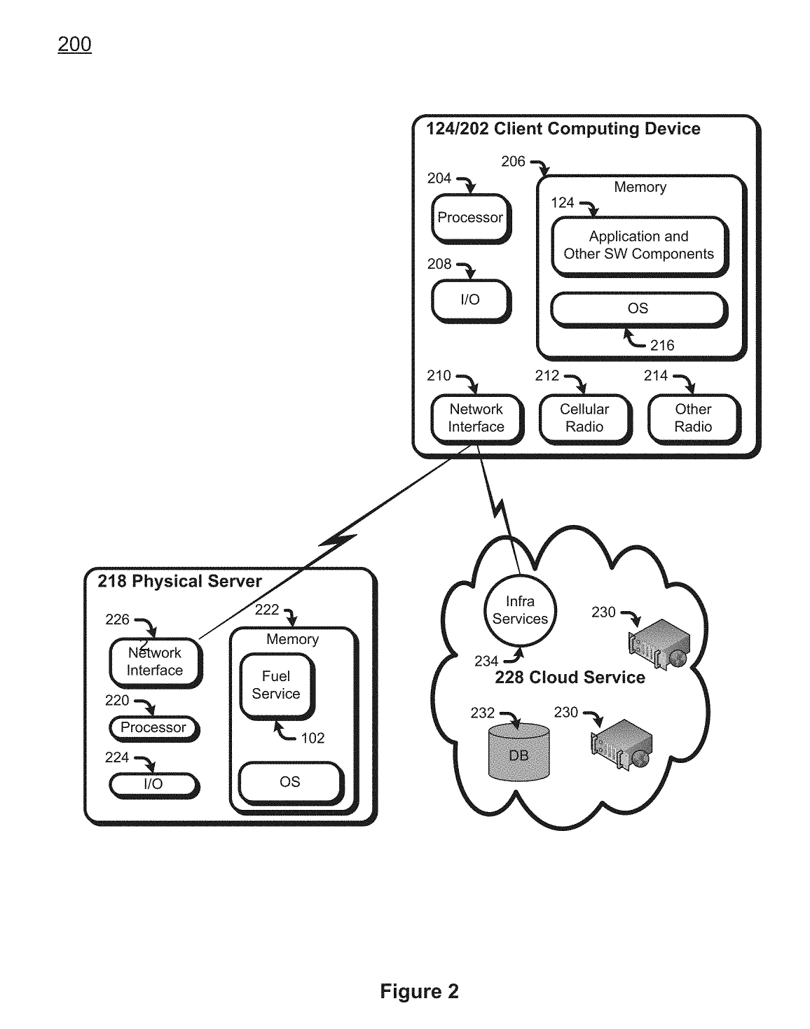

Vehicle fuel as a service is generally implemented via a fuel clearinghouse service 102, and client fuel application 124, running on a client computing device 122. FIG. 2 is an exemplary environment diagram 200 describing the hardware, software and communications environment for vehicle fuel as a service.

The client fuel application 124 is generally hosted on a client computing device 122 which is a computing device 202. Exemplary client computing devices 202 include without limitation smart phones, embedded devices, laptops, and vehicle-based computers. As these client computing devices 202 are to access the fuel clearinghouse service 102, these client computing devices 202 are networked.

The client computing device 202 has a processor 204 and a memory 206. The processor may be a central processing unit, an application processing unit, and/or a dedicated controller such as a microcontroller.

The client computing device 202 further includes an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). Via the I/O interface 208, other hardware modules may augment the client computing device 202. Example hardware modules may include Global Positioning Satellite (GPS) or other geolocation hardware modules.

The network interface 210, may potentially work in concert with the I/O interface 208 and may be a network interface card supporting Ethernet and/or Wi-Fi and/or any number of other physical and/or datalink protocols. On many client computing devices 202, such as with smartphones, the client computing device 202 is able to participate in both cellular and unlicensed wireless communications (e.g. WiFi). In this case the network interface 210 may work in concert with one or more radios for cellular 212 or unlicensed 214 communications.

Note that in general, memory 206 is any computer-readable media which may store several software components including an operating system 216 and software components and applications such as a client fuel application 124. In general, a software component is a set of computer-executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanisms. As defined herein, computer storage media does not include communication media.

The fuel clearinghouse service 102 is generally hosted on a physical server, or on a virtual machine. Where the fuel clearinghouse service 102 is hosted on a physical server, the server 218 is any computing device that may participate in a network. The network may be, without limitation, a local area network (“LAN”), a virtual private network (“VPN”), a cellular network, or the Internet. The server 218 may be a computing device with sufficient I/O computing capacity to serve multiple clients. Specifically, the physical server 218 includes a processor 220, a memory 222, an input/output interface 224 and a network interface 226. In the memory 222 will be an operating system and server-side software including a social multimedia service.

Alternatively, the fuel clearinghouse service 102 may be hosted on a virtual machine 230 via a cloud service 228. Specifically, the cloud service 228 may represent a plurality of disaggregated servers which provide virtual machine 230 functionality and virtual storage/database 232 functionality. The disaggregated servers are physical computer servers, which may have a processor, a memory, an I/O interface and/or a network interface. The features and variations of the processor, the memory, the I/O interface and the network interface are substantially similar to those described for the physical server 218. There may be differences where the disaggregated servers are optimized for throughput and/or for disaggregation.

In other embodiments, virtual machines 230 may run container software such as Docker. Container software enables a virtual machine to execute an independent execution environment, called a container, isolated from any other containers running on the virtual machine or other virtual machines. Because the container runs on a virtual machine 230 that is already instantiated, the time to instantiate a container is much shorter than the time to instantiate a virtual machine 230. In a microservices architecture or other architecture that exploit highly elastic cloud resources, container software may be a desirable embodiment beyond that of virtual machines 230.

In addition to hosting the fuel clearinghouse service 102, machine learning/cognitive network software (not shown) and other server-side software (not shown) may be hosted on virtual machines 230.

The cloud service 228 may be made accessible via an integrated cloud infrastructure 234. Cloud infrastructure 234 not only provides access to cloud services 228 but also to billing services and other monetization services. Cloud infrastructure 234 may provide additional service abstractions such as Platform as a Service (“PAAS”), Infrastructure as a Service (“IAAS”), and Software as a Service (“SAAS”).

### Exemplary Architecture for Vehicle Fuel as a Service

FIG. 2 described the general hardware, software and communications environment for vehicle fuel as a service. FIG. 3 is a block architecture diagram 300 of the specific software and hardware comprising vehicle fuel as a service.

At the heart of vehicle fuel as a service is the fuel clearinghouse service 102 comprised of several software modules. Where a part of the fuel clearinghouse service 102 is referred to as a module or component, it is understood to be a software component comprised of computer-readable and computer-executable instructions. Databases and data stores are also understood to be software comprised of computer-readable and computer-executable instructions and themselves storing computer-readable data. While the fuel clearinghouse service 102 may be hosted on physical servers, here it is illustrated as hosted on a cloud service 104, 228.

The fuel clearinghouse service 102 is comprised of a number of software components. There is a registrar component 302 which manages accounts, profiles and payment methods for various users, including fuel providers 106a-m and fuel demand consumers 108a-n. Account and profile database 304 provides a secure data store for the various accounts and associated profiles and payment methods. The account and profile database 304 implements security and privacy features including encryption of all data at rest, to ensure compliance with legal and regulatory regimes.

Fuel providers 106a-m and fuel demand consumers 108a-n interact with the fuel clearinghouse service 102 via fuel provider portal 112 and demand consumer portal 116 respectively. The fuel provider portal 112 and demand consumer portal 116 have access not only to the registrar component 302, but also to supply posting module 306 and demand posting module 308. All supply and demands posts, and their respective states are stored in the post database 310.

Note that because all contracts may be freely exchanged on a peer to peer basis. Fuel providers 106a-m and demand consumers 108a-n may make both supply and demand posts. Consider the previous example where a demand consumer 108a-n had Seattle fuel cards and sought to exchange them for Chicago fuel cards. In this scenario, the demand consumer 108a-n would have made both a supply and a demand post.

Supply and demand posts specify preferred means for matching and fulfillment. Those means may include bids, reverse auctions, sales, as well as clearance via third parties. Clearinghouse module 312 reads the post database 310 and dispatches posts to the module capable of matching and fulfilling as specified by the respective post. Accordingly, clearinghouse module 312 has a bidding submodule 314 to implement auctions, reverse auction submodule 316 to implement reverse auctions, and online store submodule 318 where users may post supply and demand as simple offers without the need of auction. Upon matching, and then upon fulfillment, the posting database 310 is updated to reflect the change in state.

In some cases, it may be desirable for users to use third-party matching and fulfillment means. For example, it may be desirable to use third-party e-commerce platforms such as Amazon™ to post supply and demand. In this case, the clearinghouse module 312 has a third-party API submodule 320 that provides interfaces to such third-party e-commerce platforms.

The third-party API submodule 320 is not limited to matching and fulfillment services. For example, note that it may be desirable for parties to place payments and other consideration into escrow. The third-party API submodule 320 may automate interfaces with third-party escrow companies as well. Third party API services may be for the fuel clearinghouse service 102 itself. Example third-party services for the fuel clearinghouse service 102 may include reporting, cybersecurity, credit checks, and analytics.

Upon a successful matching, a contract generator module 322 generates any transactional contracts. Most typically, the contract generator module 322 would generate a purchase order. Other contracts, such as handling service agreements may also be generated, especially to support time shifting and inventory shifting scenarios. In such circumstances, there may be a need for an interface with some of the oil company APIs. Oil company interface 324 provides access to oil company APIs to make resupply requests and other related requests.

Upon fulfillment of a transaction, payment component 326 is invoked by the fuel clearinghouse service 102. The payment component 326 calculates transactional fees for the fuel clearinghouse service 102. The payment component may calculate flat fees, simple percentages or graduated percentages. Depending on the jurisdiction, the payment component 326 may calculate taxes as well. In some cases, supply or demand posts may include in their offer to cover all fees. The payment component 326 will take these offers into account when calculating fees. Upon calculation, the payment component 326 will invoke the payment method associated with the fuel provider 106a-m and/or the demand consumer 108a-n to effect payment. Upon payment, the payment component 326 updates the posting database 310 to indicate payment is complete.

Note that after the transaction, tracking still continues. The usage monitoring component 328 receives indications that fuel codes 126 are being used at the gas stations 110a-q. As the fuel codes 126 are run down, the posting database 310 stores the quantity of fuel, location, and time that the fuel codes 126 were used. In this way, the fuel clearinghouse service 102 may track the consumption of provided fuel and/or the meeting of fuel demand. In some cases, analytics techniques may be applied to search for usage patterns, or to detect instances of fraud.

At any point in time, the administration portal 132 may review the state of postings from the posting database 310. From the administration portal 132, various reports may be generated to review users, posts and transactions, and generally to perform analytics to detect usage patterns.

Note also that the provider portal 112 and the demand consumer portal 116 may have limited access to the usage monitoring component 328 and the reporting functionality including the contract generator module 322 and the custom reports module 330. Specifically, the provider portal 112 and the demand consumer portal 116 will only have access to contracts and posts that the respective fuel provider or demand consumer has participated in. However, fuel providers and demand consumers may specify custom queries and generate custom reports to provide a centralized view of all contracts and posts that they have participated in respectively. In this way, regardless of the number of client fuel applications 124 in the field and how geographically disparate those client fuel applications 124 are, a demand consumer may monitor and analyze usage patterns and a fuel provider may analyze sales and distribution patterns.

Usage patterns may simply be to determine trends. In some cases, usage patterns may suggest potential strategies to change usage and purchase patterns to save money or perform some other optimization. In other cases, usage patterns may be to detect fraud or theft.

As described in the foregoing, the fuel clearinghouse service 102 embodies a vehicle fuel as a service implementation that provides peer to peer and cooperative fuel exchange. In effect, it provides a platform to enable parties to post an arbitrary quantity of fuel for sale/exchange and match to an arbitrary demand. From the perspective of fuel providers 106a-m, they are able to access a broader market to liquidate excess inventory. For example, a gas station in Chicago otherwise would not have been aware of a Seattle based trucking company needing gas in Chicago. From the perspective of demand consumers 108a-n, they have more options to obtain fuel, and accordingly with more choice, may realize savings in fuel expenses.

It is to be emphasized the fuel clearinghouse service 102 provides a technical solution to a number of technical problems which give rise to a number of technical benefits. While the clearinghouse module 312 in fact performs matching of posts, it is configurable and extensible for an arbitrary type of matching and bidding process. It has the capability of receiving software modules, such as the reverse auction submodule 316, bidding submodule 314 and other types of matching and bidding modules. In concert with the contract generator module 322, and the payment component 326 the clearinghouse service 102 is able to resolve requirements from the demand consumer profile, the fuel provider profile, potentially the oil companies, beyond the specification of a demand post or a supply post. In this way, beyond matching posts, the clearinghouse service 102 accounts for restrictions beyond the facial specifications of the posts. Furthermore, the clearinghouse service 102 is able to not merely match, but also rank the desirability of matches, and to prioritize matches.

Because of the distributed nature of the fuel clearinghouse service 102, the clearinghouse service 102 can be seen as a just-in-time fuel service. Fuel providers and demand consumers may create contracted transactions without having ever met, and without having to negotiate with each other's legal teams. By abstracting out the transaction process, the fuel clearinghouse service 102 standardizes fuel transfer in bulk quantities without the need for protracted negotiations.

Furthermore, the fuel clearinghouse service 102 provides a centralized reporting and analytics system for fuel providers and demand consumers alike. Because the contracts and posts and usage information are centralized, the fuel clearinghouse service 102 aggregates fuel transfer data in statistically significant amounts to perform machine learning and cognitive learning analytics.

Additional advantages in virtualizing fuel supply and demand are described in later sections.

### Exemplary Method for Posting and Fulfilling Supply and Demand Posts via Vehicle Fuel as a Service

Turning to FIG. 4, 400 is a flow chart of general operational steps in using vehicle fuel as a service. In block 402, a user registers with the fuel clearinghouse service 102. The user may be either a fuel provider 106a-m or a demand consumer 108a-n. Depending on the type of user, the user accesses the fuel clearinghouse service 102 via the provider portal 112 or the demand consumer portal 116. The portals 112 and 116 interface with the registrar component 302. Upon presentation of proper credentials, the registrar component 302 accepts account information, profile information, and payment information, and stores it in account and profile database 304.

Fuel providers 106a-m may specify the identities and locations of gas stations 110a-q under their control. In this way, the fuel provider 106a-m may specify not only fuel quantity of fuel location when making supply posts 128.

Fuel providers 106a-m, one may also specify the oil company 114a-o that particular gas stations 110a-q of the fuel provider 106a-m are affiliated with. Some fuel providers 106a-m may have exclusive contracts to carry only products from a particular fuel company 114a-o, so that resupply contracts, such as handling service agreements are to be provided only by that particular oil company 114a-o. Note that some fuel providers 106a-m may have different agreements for different sets of gas stations 110a-q. For this reason, the oil company 114a-o is associated with gas stations 110a-q rather than just the fuel provider 106a-m.

Fuel demand consumers 108a-n, may register vehicles 118a-p comprising their fleet. The vehicles 118a-p may have telematics computers, or personal computing devices 122 that run a client fuel application 124 that may receive fuel codes 126 that may be redeemed at gas stations 110a-q of fuel providers 106a-m. By tracking vehicles 118a-p in fleets, the fuel clearinghouse service 102 may track vehicles and demand on an individual basis including the location and quantity of fuel consumption. From a macroscopic level, the client fuel application 124 may simply track that purchased fuel is consumed. From a fine-grained level, the client fuel application 124 may provide demand information as it evolves over location and time for the demand consumer 108a-n.

In block 404, a user creates either a fuel supply post 128 or a fuel demand post via portal 112, 116. If a fuel supply post 128 is created, the supply posting module 306 collects the supply post 128 information and stores it in the post database 310. Similarly, if a demand supply post 130 is created, the demand posting module 308 collects the demand post 130 information and stores it in the post database 310.

Post information ranges from non-specific to very specific. At a minimum, a post comprises either a demand or a supply of a quantity of fuel. The post can specify a wide range of method of the fuel to be specified. The fuel may be specified via fuel cards 120. In this case, fulfillment is the physical transfer of the fuel cards 120 from one user to another.

In another embodiment, the quantity of fuel may be specified as fuel codes 126 redeemable at particular gas stations 110a-q under the control of a fuel provider 106a-m. In this scenario, fuel cards 120 are bypassed and fuel codes 126 may be electronically distributed to client fuel applications 124 on the client computing devices 122 of the fleet vehicles 118a-p. In this way, fulfillment and distribution may be achieved electronically.

In yet another embodiment, the quantity of fuel may be specified as a contract to resupply a particular gas station or set of gas stations 110a-q. In this scenario, the purchase of fuel is actually a promise to restock fuel. Fulfillment is either by invoking an existing handling service agreement, or by creating a new handling service agreement with an oil company. The fuel clearinghouse service 102 need not take payment for the restocking fees or fuel inventory. Rather the contract generator module 322 may interface directly with the oil company via interface 324. The purchaser may use their payment means on file with the fuel clearinghouse service 102 via the account and profile database 304, or may make third-party arrangements to pay via third-party API module 320. In other embodiments, a third-party escrow service may be invoked via the third-party API module 320 as well. When the oil company interface 324 indicates that payment or promise to pay is sufficient, the restocking action is fulfilled.

Location of fuel is one particular possible parameter for a supply post 128 or demand post 130. Not only is a quantity of fuel specified, but also the geolocations of where the fuel may be collected. Typically, this is specified by indicating gas stations 110a-q of a fuel provider 106a-m.

Expiration time window is another possible parameter for a supply post 128 or a demand post 130. Expiration time window is a date beyond when either the fuel supply in a supply post 128 or the fuel demand in a demand post 130 expires. Reasons for expiration vary. For example, in a supply post 128, a fuel provider 106a-m may have ethanol fuel which spoils faster than ordinary gasoline. A fuel provider 106a-m in that situation may specify an expiration date for which past the date the fuel will have spoiled and will not be fit for sale. By way of another example, in a demand post 130, a demand consumer 108a-n may have trucks scheduled to be in Chicago on the 15th or 16th of a particular month but on their way to New York City. Since the trucks are expected to no longer be proximate to Chicago past the 16th, and therefore will not be of need of Chicago located fuel, the demand post 130 may set an expiration for the 16th.

In some cases, groups of users may make temporary associations to make a joint posting. In this way, more competitive postings might be created. For example, a set of fuel providers in the Pacific Northwest, Northern California, and Southern California, may make a joint bid to offer fuel. By making a temporary association, the entire stretch from Seattle to San Diego may be covered. Temporary associations may also be made by demand consumers 108a-n. For example, a larger set of demand consumers 108a-n may make larger posts for fuel, and may be able to demand better prices.

A posting may also specify which party or parties are covering transaction fees for the fuel clearinghouse service 102. In some cases, a posting may offer to cover all the transaction fees. In other cases, a posting may specify that bids are to include the covering of transaction fees. Where a posting does not specify which party or parties are covering transaction fees, payment terms will default to the registered terms of use for the users, for example, to split fees 50/50.

A posting 128 or 130 also specifies the means that the posting is to be presented to other users. Specifically, a posting may be put up for auction, put up for reverse auction, posted for sale, or posted via a third party.

Upon completion of specifying a posting, the supply posting module 306 posts the supply post 128 or the demand posting module 308 posts the demand post 130 to the posting database 310.

In block 406, the clearinghouse module 312 reads the post in posting database 310. Depending on the means of presentation as specified in the post, the clearinghouse module 312 will dispatch the post to a bidding submodule 314 for auctions, a reverse auction submodule 316 for reverse auctions, and an online store module 318 for simple posts for sale. In some cases, a user will opt to use a third-party e-commerce solution, such as Amazon™. In these cases, the clearinghouse module 312 will forward posts to those third-party solutions via third-party API module 320, where the third-party APIs are invoked to forward the posts.

In some embodiments, the clearinghouse module 312 validates matches on the basis of one or more of the profiles of the demand consumers, fuel providers, and oil companies. In cases where restrictions set forth in those profiles are not satisfied, bids will not be accepted, and the clearinghouse module 312 will provide a notification to the respective portal. In other embodiments, the clearinghouse module 312 will prioritize bids, not on the order received, but based on an evaluation of best fit with respect of one or more of the profiles of the demand consumers, fuel providers, and oil companies.

In block 408, when a post has received an offer or a bid acceptable to the posting user, the contract generator module 322 is invoked by the fuel clearinghouse service 102. Depending on the type of transaction, a purchase order may be generated or alternatively a bill of exchange. In the cases where fuel inventory is transferred, a handling service agreement may be invoked via oil company interface 324.

In block 410, the clearinghouse module 312 then verifies that the generated contract has been accepted by the parties. Verification may be via electronic signature. Alternative presentation of credentials via the portals 112 and/or 116 may be used to verify agreement to the contracts. In the case of third-party services, verification messages via the third-party APIs 320 may be used to verify the agreement.

In block 412, after verification, the fuel clearinghouse service 102 via the payment component 326 will debit fees from the payment methods of the respective users as specified in the post. Recall that users may agree on how to subdivide fees ranging from the posting user paying for all fees or the bidding user paying for all fees, or some other mix. At this point, the fuel clearinghouse service 102, via the payment component 326 will update the posting database 310 to indicate the posting has been cleared.

One of the features of the fuel clearinghouse service 102 is that contracts, may be resold either in full, or partially. For example, a user may purchase a quantity for fuel cards 120 for Chicago, but it may turn out not to need all the cards 120. The user may then repost the cards. Note that for this reason, even a demand consumer 108a-n may have occasion to act as a fuel provider, here with the cards.

Accordingly, in block 414, a user may repost either in full, or in part a prior posting for resale or exchange. This is performed from a portal 112 or a portal 116. A user recalls the original post from the post database 310, and creates a new post using a combination of information from the original post, as well as usage data collected from vehicles in a demand consumer's fleet 118a-o. The posting modules 306 and 308 can determine how much fuel has been used, or alternatively how much demand has been serviced. The quantities of available fuel or fuel demanded are adjusted accordingly. If needed, additional information, such as information for creating a temporary association with other users, is collected, and the new posting posted via the supply posting module 306 or the demand posting module 308.

### Exemplary Method for Tracking Supply and Demand for Posts via Vehicle Fuel as a Service

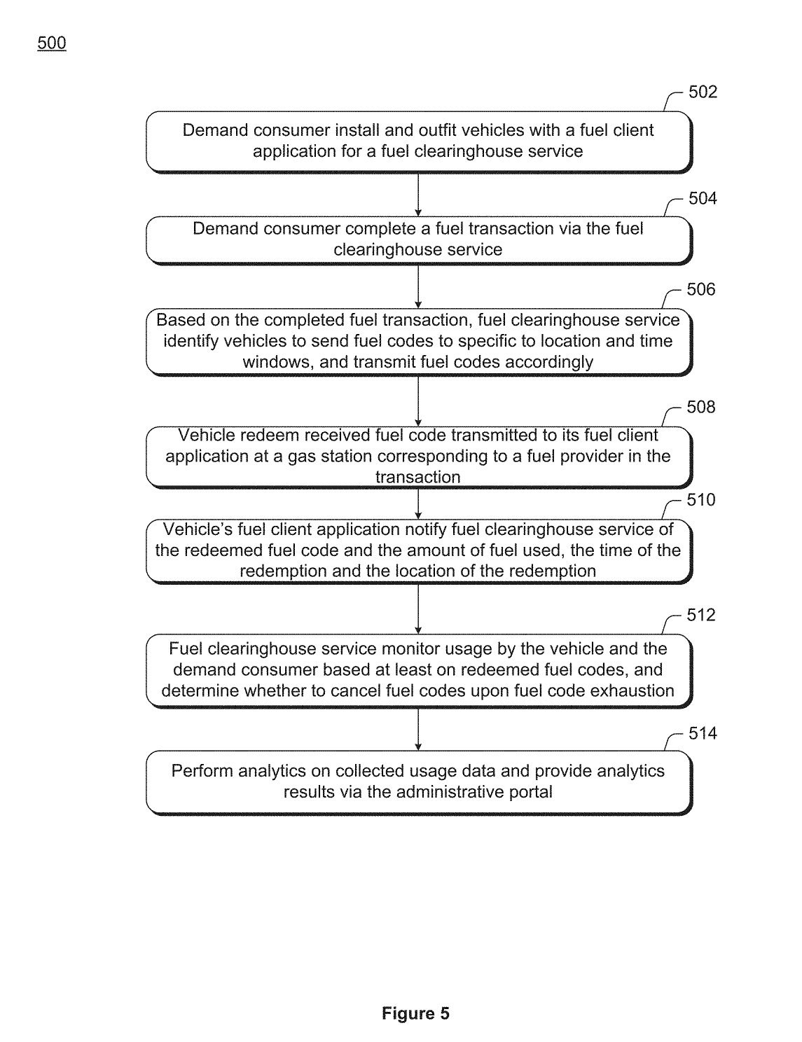

Once a transaction is completed, the fuel clearinghouse service 102 continues to track the supply and demand of fuel in posts. FIG. 5 is a flow chart 500 of an exemplary method to track supply and demand for posts via the fuel clearinghouse service 102.

In block 502, a demand consumer 108a-n outfits its vehicles 118a-o with client computing devices 122 running client fuel applications 124. The client application is able to determine the location of the various vehicles using GPS or other geolocation technologies. In some cases, a demand consumer 108a-n may also specify itineraries to more clearly indicate the planned location for vehicles 118a-o.

In block 504, a transaction is completed where fuel is to be supplied via fuel code 126. The transaction includes the quantity of fuel, the location, and an expiry time window.

In block 506, the clearinghouse module 312 then identifies the vehicles to send fuel codes to 126, in what time window, and to which vehicles based on vehicle locations. Upon identification, the fuel codes 126 are electronically transmitted to the vehicles 118a-o and their respective client computing devices 122 and client fuel applications 124.

In block 508, a vehicle 118a-o redeems a fuel code 126 at a gas station 110a-q, either in full or in part. Note that unlike fuel cards 120, fuel codes may apply to an entire quantity of gas. Specifically, if two vehicles 118a-o have the same fuel code for 100 gallons of fuel, the fuel code remains valid regardless of if the first vehicle uses 2 gallons, 50 gallons, or 98 gallons of the 100 gallons of fuel. In other words, the fuel code remains valid as long as there is fuel associated with the code.

After redeeming a fuel code 126, in block 510 the client fuel application 124 transmits a message indicating the locations, quantity, and time that the fuel code was redeemed to the usage monitoring component 328 of the fuel clearinghouse service 102.

In block 512, the usage monitoring component 328 receives the transmitted message and stores an update to the posting database 310. The usage monitoring component 328 determines whether the fuel code 126 is exhausted. If so, it cancels the fuel code 126. Otherwise, operation continues normally.

In block 514, from time to time, the usage patterns may be retrieved by the administrative portal 132 and analytics techniques applied. In some cases, the analytics will be to determine usage patterns for fuel distribution. In other cases, the analytics will be to determine whether fuel codes 126 are being subjected to fraud, theft, or other illegal activity.

### Example Use Cases of Vehicle Fuel Management as a Service

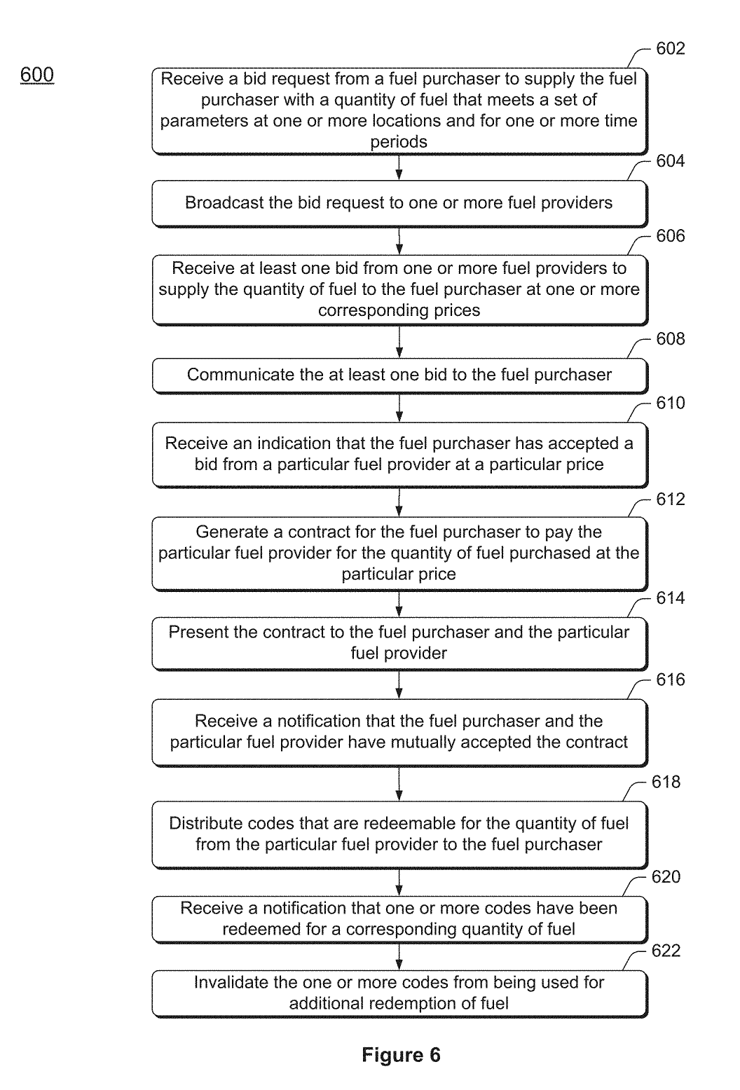

FIGS. 6-9 present illustrative processes 600-900 for using a fuel clearinghouse service to fulfill the demands of demand consumers for fuel by brokering the distribution fuel demands and fuel inventory to fuel providers. Each of the processes 600-900 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described each of the flow charts is not intended to be construed as a limitation, and any number of the described blocks can be combined in any order and/or in mirror to implement the process.

FIG. 6 is a flow chart of an example process 600 for a fuel clearinghouse service to assist a demand consumer in obtaining fuel from a fuel provider through bidding by multiple fuel providers. The example process 600 may enable a demand consumer to time shift the purchase of fuel to advance purchase rather than purchase at the time of individual fuel fill-ups.

In block 602, the fuel clearinghouse service 102 may receive a bid request from a demand consumer to supply the demand consumer with a quantity of fuel that meets a set of parameters at one or more locations and for one or more time periods. The demand consumer may be a vehicle fleet operator that has a large number of vehicles that require fill up of fuel at periodic intervals. For example, the vehicle fleet operator may be a trucking company that deploys trucks to ship products over a large geographical area, a long-distance transportation company that operates a fleet of passenger vehicles that make scheduled stops at different destinations, etc. The fuel that is needed by the demand consumer may be gasoline, diesel, kerosene, liquefied natural gas, alcohol fuels, or any combination thereof. The set of parameters may include fuel grade, fuel octane rating, fuel purity rating, fuel mixture percentages, fuel expiration date, fuel energy content, and/or so forth. The locations may be at or near places that are on the routes traversed by the vehicles of the demand consumer, places where the vehicles make scheduled stops, places where the demand consumer has maintenance, repair, or overhaul facilities, and/or so forth. Each of the time periods may be measured in hours, days, weeks, and/or forth. The quantity of the fuel may be measured in gallons, liters, cubic feet, and/or so forth, depending on the nature of the fuel. In order for the demand consumer to place a bid request with the fuel clearinghouse service 102, the demand consumer is required to register with the service by providing registration information. The registration information may include the identification information, contact information (e.g., email address, postal mail address, phone number, etc.), authentication credentials, and/or financial account information. The authentication credentials enable the demand consumer to access a portal (e.g., website) provided by the fuel clearinghouse service 102. The financial account information may enable the fuel clearinghouse service 102 to bill the demand consumer a one-time fee and/or recurring subscription fees for using the services provided by the fuel clearinghouse service 102. The registration may be performed via the portal of the fuel clearinghouse service 102.

In block 604, the fuel clearinghouse service 102 may broadcast the request to one or more fuel providers. A fuel provider is an operator of one or more fuel filling stations that sell fuel to the general public through fuel dispensers. The fuel provider may be an independent operator, or an operator that is affiliated with a particular fuel producer or refinery, e.g., oil company. As described above, a fuel provider that is affiliated with a particular fuel producer or refinery is obligated to purchase fuel stock from the particular in-network fuel producer or refinery for resale to the public. In various embodiments, the fuel clearinghouse service 102 may broadcast the bid request to the fuel providers through the portal, via electronic mail distribution, via text message distribution, and/or other electronic information distribution mechanisms.

In order for a fuel provider to receive and act on a bid request, the fuel provider is required to register with the fuel clearinghouse service 102 by providing registration information. The registration information may include the identification information, contact information (e.g., email address, postal mail address, phone number, etc.), authentication credentials, and/or financial account information. The authentication credentials enable the fuel provider to access the portal provided by the fuel clearinghouse service 102. The financial account information may enable the fuel clearinghouse service 102 to bill the fuel provider a one-time fee and/or recurring subscription fees for using the services provided by the fuel clearinghouse service 102. Additionally, the fuel clearinghouse service 102 may also use the financial account information to bill the fuel provider a fee that is proportional to the quantity of the fuel sold in each bid transaction. The registration may be performed via the portal of the fuel clearinghouse service 102.

In block 606, the fuel clearinghouse service 102 may receive at least one bid from one or more fuel providers to supply the quantity of fuel to the demand consumer that meets the set of parameters at one or more corresponding prices. A fuel provider may input a bid through an auction function that is built into the portal of the service. In various instances, a fuel provider may input other information along with the bid. The information may include locations of the fuel filling stations operated by the fuel provider, ancillary services and amenities that are provided by the fuel provider at the fuel filling stations, hours of operations, reputation reviews or ratings of the fuel provider, and/or other relevant information. In some embodiments, a bid may be submitted by a conglomerate of multiple fuel providers rather than a single provider. For example, multiple fuel providers may decide to cooperatively band together to make their bid more attractive in terms of competitive pricing, greater number and/or locations of available fuel filling stations, fuel filling stations that are closer in proximity to the locations designated in the bid request, more hours of operation, and/or other factors.

In block 608, the fuel clearinghouse service 102 may communicate the at least one bid to the demand consumer. The bid may be presented via a portal, or communicated through various electronic information distribution channels (e.g., email, text, automatic voice mails, etc.) that are capable of reaching the demand consumer.

In block 610, the fuel clearinghouse service 102 may receive an indication that the demand consumer has accepted a bid from a particular fuel provider at a particular price. In various embodiments, the demand consumer may use the auction function built into the portal of the service to accept the bid. For example, the demand consumer may be motivated to accept a bid that offers the most competitive (e.g., lowest) price for the quantity of fuel. However, the demand consumer may also be influenced by other factors, such as locations of the fuel stations, hours of operations, provider reputation, etc. to select a particular bid. In some instances, the accepted bid may be from a conglomerate of fuel providers rather than a single provider.

In block 612, the fuel clearinghouse service 102 may generate a contract for the demand consumer to pay the particular fuel provider for the quantity of fuel purchased at the particular price. In some instances, the contract may state that the demand consumer is to pay a fee directly to the particular fuel provider that is equal to the particular price. In other instances, the contract may be a handling service contract in which the demand consumer agrees to directly pay an in-network fuel producer or refinery associated with the particular fuel provider a fee for an equivalent quantity of fuel, as well as pay the particular fuel provider a service fee for supplying the quantity of fuel to the demand consumer, in which the total fees paid by the demand consumer is equal to the particular price. Alternatively, the total fees paid by the demand consumer is equal to the particular price and applicable governmental charges, in which the governmental charges must be forwarded by the particular fuel provider to the responsible governmental entity. In various embodiments, the contract may be generated based on the information supplied by the demand consumer and the particular fuel provider at the time of registration. The contract may contain payment terms and conditions that ensure the demand consumer pays the fuel provider.

In block 614, the fuel clearinghouse service 102 may use the portal to present the contract to the demand consumer and the particular fuel provider. In various embodiments, the contract may be presented as an electronic document, and each party may provide an electronic signature and/or acknowledgment via the portal to indicate that the party agrees to the contract.

In block 616, the fuel clearinghouse service 102 may receive a notification from the portal that the demand consumer and the particular fuel provider have mutually accepted the contract. For example, each party may accept the contract by providing a legally enforceable electronic signature and/or acknowledgment. Following the provision of the electronic signature and/or acknowledgment by all the parties, the portal may send the notification to the service. In some instances, the notification may trigger the fuel clearinghouse service 102 to automatically deduct from a financial account of the fuel provider a flat service fee or a service fee that is a percentage of the particular price paid by the demand consumer. However, in other instances, the fuel clearinghouse service 102 may be configured to deduct a fee following actual distribution of the fuel to the vehicles of the demand consumer. In some instances, the terms and conditions of the contract may stipulate that the payment is entirely handled by the demand consumer and the particular fuel provider without the involvement of the fuel clearinghouse service operator. However, in other instances, the operator of the fuel clearinghouse service 102 may act as an escrow agent, such that the demand consumer pays the operator of the service for the quantity of fuel, and the operator of the service then delivers one or more payments to the fuel provider after the entire quantity of fuel or each predetermined portion of the quantity of fuel has been distributed by the particular fuel provider to the vehicles of the demand consumer.

In block 618, the fuel clearinghouse service 102 may distribute fuel codes that are redeemable for the quantity of fuel from the particular fuel provider to the demand consumer. In various embodiments, the fuel codes may be in the form of points, vouchers, or other electronic credits, in which each fuel code is redeemable for a corresponding amount of fuel from one or more fuel filling stations of the particular fuel provider. In some embodiments, the service may distribute the fuel codes via email, text, as credit on a reloadable electronic or magnetic value card, or credit on a reloadable electronic wallet application on a mobile device (e.g., a smartphone), credit stored in a vehicle computer, or so forth, to the demand consumer or authorized agents of the demand consumer.

In block 620, the fuel clearinghouse service 102 may receive a notification that one or more fuel codes have been redeemed for a corresponding quantity of fuel. In some instances, the notification may be an automatic real-time or near real-time notification that is sent by an electronic reader (e.g., a magnetic card reader, an RFID reader, a code reader, a chip reader, etc.) that is installed at the fuel dispensers of the particular fuel provider. Each of the installed electronic reader may be own and/or maintained by the operator of the fuel clearinghouse service or by the particular fuel provider. In other instances, the notification may be a periodic notification (e.g., a daily report) that is submitted by the particular fuel provider to the fuel clearinghouse service 102 via the portal.

In block 622, the fuel clearinghouse service 110a-q may invalidate the one or more redeemed fuel codes from being used for additional redemption of fuel. In instances in which the fuel clearinghouse service 102 is configured to deduct a fee from the particular fuel provider following the delivery of the fuel, the redemption of the fuel codes may trigger the service to deduct a corresponding fee from the financial account of the particular fuel provider.

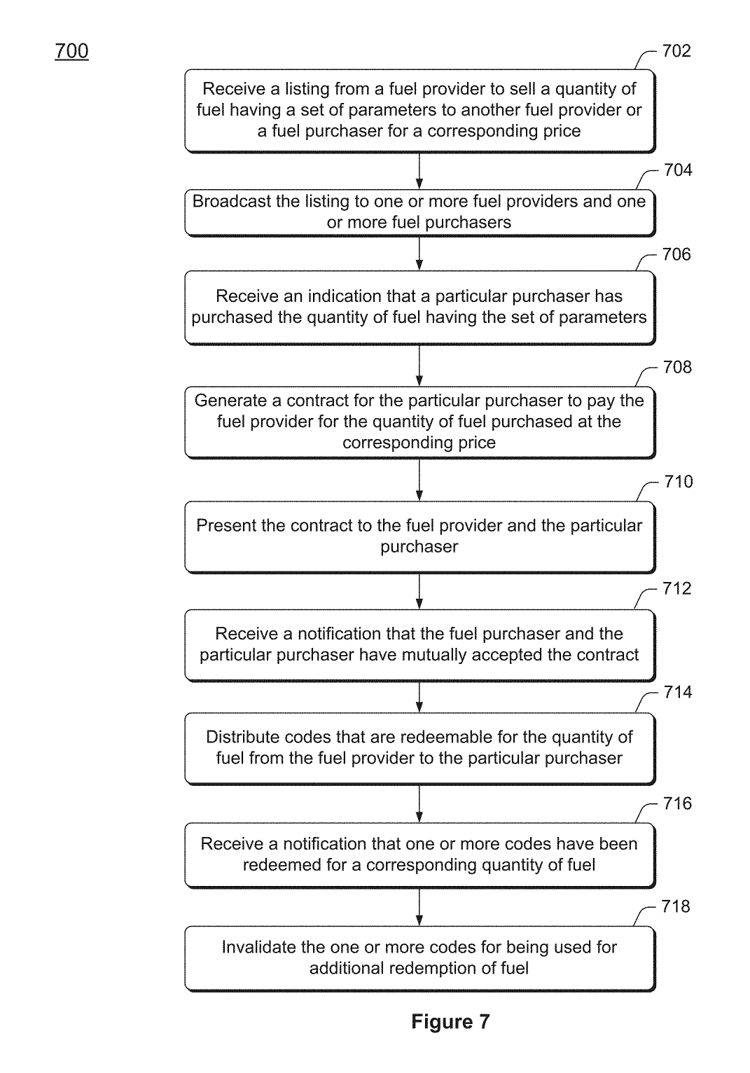

FIG. 7 is a flow chart of an example process 700 for a fuel clearinghouse service to assist a fuel provider in selling fuel inventory to a fuel purchaser or another fuel provider. The example process 700 may enable the fuel provider to shift the fuel inventory of the fuel provider to another fuel provider or to proactively use the fuel inventory to meet the fuel demand of a demand consumer. Such fuel inventory shifting may in some instances allow the fuel provider to avoid fuel spoilage.

In block 702, the fuel clearinghouse service 102 may receive a listing from a fuel provider to sell a quantity of fuel having a set of parameters to another fuel provider or a demand consumer for a corresponding price. In various embodiments, each of the fuel providers and demand consumers may be registered with the fuel clearinghouse service 102 as described in example process 600. The listing may be submitted via a sales transaction function built into a portal (e.g., web site) of the service by the fuel provider. The set of parameters may include fuel grade, fuel octane rating, fuel purity rating, fuel mixture percentages, fuel expiration date, fuel energy content, and/or so forth. In some instances, the listing may also indicate an expiration date for the fuel. For example, the fuel may include a fuel additive/ingredient that degrades or evaporates over time. Accordingly, the fuel may have a limited shelf life due to gradual deterioration in quality, combustibility, and/or other properties.

In block 704, fuel clearinghouse service 102 may broadcast the listing to one or more fuel providers and one or more demand consumers that are registered with the service. In various embodiments, the fuel clearinghouse service 102 may broadcast the listing through the portal, via electronic mail distribution, via text message distribution, and/or other electronic information distribution mechanisms.

In block 706, the fuel clearinghouse service 102 may receive an indication from the sales transaction function that a particular purchaser has purchased the quantity of fuel having the set of parameters. The particular purchaser may be a demand consumer, another fuel provider, or a conglomerate of fuel providers. In various embodiments, the purchaser may make the purchase by activating a buy option presented by the sales transaction function for listing. In turn, the sales transaction function generates the indication.

In block 708, the fuel clearinghouse service 102 may generate a contract for the particular purchaser to pay the fuel provider for the quantity of fuel purchased at the corresponding price. In some instances, the contract may state that the particular purchaser is to pay a fee directly to the fuel provider that is equal to the corresponding price. In other instances, the contract may be a handling service agreement in which the particular purchaser agrees to directly pay an in-network fuel producer or refinery associated with the fuel provider a fee for an equivalent quantity of fuel, as well as pay the particular fuel provider a service fee for supplying the quantity of fuel, in which the total fees paid by the particular purchase is equal to the corresponding price. Alternatively, the total fees paid by the demand consumer is equal to the corresponding price and applicable governmental charges, in which the governmental charges must be forwarded by the fuel provider to the responsible governmental entity. In various embodiments, the contract may be generated based on the information supplied by the particular purchaser and the fuel provider at the time of registration. The contract may contain payment terms and conditions that ensure the particular purchaser pays the fuel provider.

In block 710, the fuel clearinghouse service 102 may use the portal to present the contract to the fuel provider and the particular purchaser. In various embodiments, the contract may be presented as an electronic document, and each party may provide an electronic signature and/or acknowledgment via the portal to indicate that the party agrees to the contract.

In block 712, the fuel clearinghouse service 102 may receive a notification from the portal that the particular purchaser and the fuel provider have mutually accepted the contract. For example, each party may accept the contract by provide a legally enforceable electronic signature and/or acknowledgment. Following the provision of the electronic signature and/or acknowledgment by all the parties, the portal may send the notification to the service. In some instances, the notification may trigger the fuel clearinghouse service 102 to automatically deduct from a financial account of the fuel provider a flat service fee or a service fee that is a percentage of the corresponding price paid by the demand consumer. However, in other instances which the particular purchaser is demand consumer, the fuel clearinghouse service 102 may be configured to deduct a fee following actual distribution of the fuel for use. In some instances, the terms and conditions of the contract may stipulate that the payment is entirely handled by the particular purchaser and the fuel provider without the involvement of the fuel clearinghouse service operator. However, in other instances, the operator of the fuel clearinghouse service 102 may act as an escrow agent, such that the particular purchaser pays the operator of the service for the quantity of fuel, and the operator of the service then delivers one or more payments to the fuel provider after the entire quantity of fuel or each predetermined portion of the quantity of fuel has been distributed by the fuel provider for use.

In block 714, the fuel clearinghouse service 102 may distribute fuel codes that are redeemable for the quantity of fuel from the fuel provider to the particular purchaser. In various embodiments, the fuel codes may be in the form of points, vouchers, or other electronic credits, in which each fuel code is redeemable for a corresponding amount of fuel from one or more fuel filling stations of the particular fuel provider. In some embodiments, the service may distribute the fuel codes via email, text, as credit on a reloadable electronic or magnetic value card, or credit on a reloadable electronic wallet application on a mobile device (e.g., a smartphone), credit stored in a vehicle computer, or so forth, to the particular purchaser. In instances in which the particular purchaser is a demand consumer, the demand consumer may further distribute the fuel codes to the authorized agents of the demand consumer to obtain fuel from the filling stations of the fuel provider. In instances in which the particular purchaser is another fuel provider, the other fuel provider may sell the fuel codes with a markup to demand consumers. In turn, these demand consumers may then redeem the fuel codes for fuel at the filling stations of the fuel provider.

In block 716, the fuel clearinghouse service 102 may receive a notification that one or more fuel codes have been redeemed for a corresponding quantity of fuel. In some instances, the notification may be an automatic real-time or near real-time notification that is sent by an electronic reader (e.g., a magnetic card reader, a RFID reader, a code reader, a chip reader, etc.) that is installed at the fuel dispensers of the particular fuel provider. Each of the installed electronic reader may be own and/or maintained by the operator of the fuel clearinghouse service or by the particular fuel provider. In other instances, the notification may be a periodic notification (e.g., a daily report) that is submitted by the particular fuel provider to the fuel clearinghouse service 102 via the portal.

In block 718, the fuel clearinghouse service 110a-q may invalidate the one or more redeemed fuel codes from being used for additional redemption of fuel. In instances in which the fuel clearinghouse service 102 is configured to deduct a fee from the fuel provider following the delivery of the fuel, the redemption of the fuel codes may trigger the service to deduct a corresponding fee from the financial account of the fuel provider.

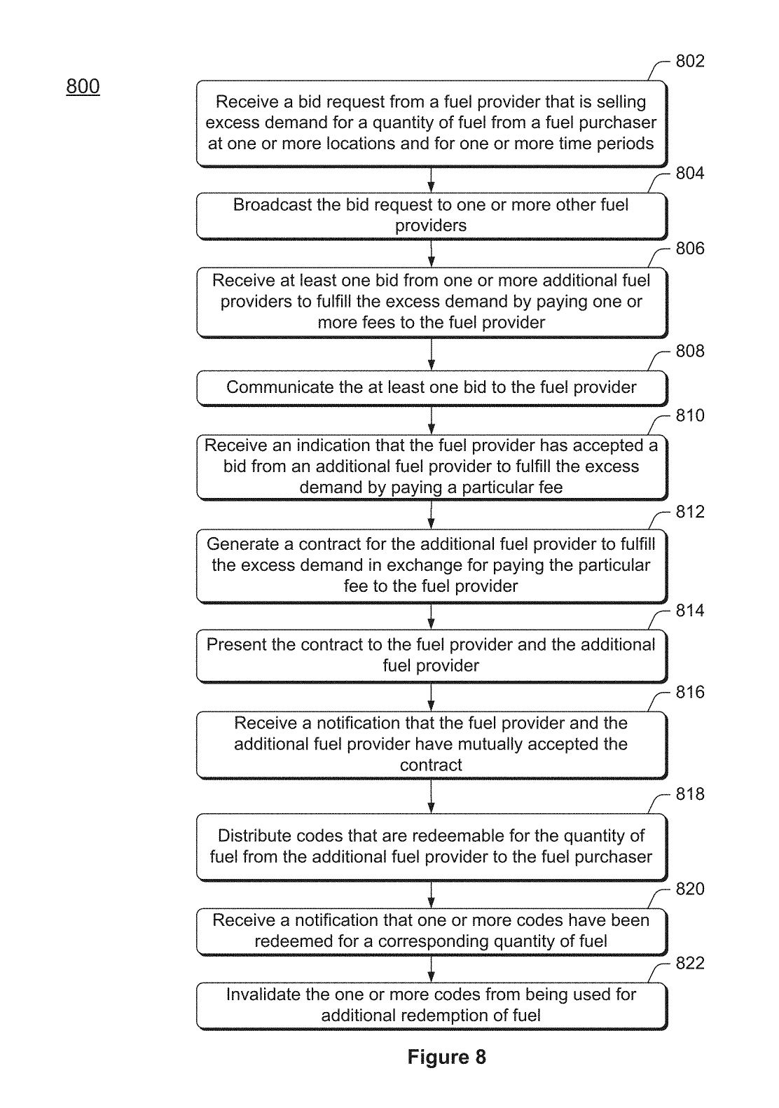

FIG. 8 is a flow chart of an example process 800 for a fuel clearinghouse service to assist a fuel provider in selling excess demand for fuel to another fuel provider. The example process 800 may enables the fuel provider to location shift a demand consumer to the fuel filling stations of another fuel provider in order to meet the fuel demand of the demand consumer.

In block 802, the fuel clearinghouse service 102 may receive a bid request from a fuel provider that is selling excess demand for a quantity of fuel from a demand consumer at one or more locations and for one or more time periods. The excess demand for the fuel may include a set of parameters that the fuel is to meet. The set of parameters may include fuel grade, fuel octane rating, fuel purity rating, fuel mixture percentages, fuel expiration date, fuel energy content, and/or so forth. The locations may include places that are on the routes traversed by the vehicles of the demand consumer, places where the vehicles make scheduled stops, places where the demand consumer has maintenance, repair, or overhaul facilities, and/or so forth. Each of the time periods may be measured in hours, days, weeks, and/or forth. The quantity of the fuel may be measured in gallons, liters, cubic feet, and/or so forth, depending on the nature of the fuel.

In order for a fuel provider to submit a bid request, the fuel provider is required to register with the fuel clearinghouse service 102 by providing registration information. The registration information may include the identification information, contact information (e.g., email address, postal mail address, phone number, etc.), authentication credentials, and/or financial account information. The authentication credentials enable the fuel provider to access a portal provided by the fuel clearinghouse service 102. The financial account information may enable the fuel clearinghouse service 102 to bill the fuel provider a one-time fee and/or recurring subscription fees for using the services provided by the fuel clearinghouse service 102. Additionally, the fuel clearinghouse service 102 may also use the financial account information to bill the fuel provider a fee that is proportional to the quantity of the fuel sold in each bid transaction. The registration may be performed via the portal of the fuel clearinghouse service 102.

In block 804, the fuel clearinghouse service 102 may broadcast the request to one or more other fuel providers. In various embodiments, the fuel clearinghouse service 102 may broadcast the bid request to the fuel providers through a portal (e.g., website), via electronic mail distribution, via text message distribution, and/or other electronic information distribution mechanisms. It will be appreciated that each of the fuel providers described in block 602 and 604 is an operator of a fuel filling station that sells fuel to the general public through fuel dispensers. The fuel provider may be an independent operator, or an operator that is affiliated with a particular fuel producer or refinery. A fuel provider that is affiliated with a particular fuel producer or refinery is obligated to purchase fuel stock from the particular in-network fuel producer or refinery for resale to the public. The fuel providers described in block 604 are registered with the fuel clearinghouse service 102 in the same manner as the fuel provider in block 602.

In block 806, the fuel clearinghouse service 102 may receive at least one bid from one or more additional fuel providers to fulfill the excess demand by paying one or more fees to the fuel provider. In other words, the additional fuel providers are bidding to purchase the excess demand from the fuel provider. Accordingly, each of the additional fuel providers may be seeking to bid the lowest fee payment for the excess demand, taking into account a profit margin that the additional fuel provider desires to make by fulfilling the excess demand. Each of the bids is to meet the set of parameters for the fuel, as well as satisfy the location and time period specification of the bid request.

An additional fuel provider may input a bid through an auction function that is built into the portal of the service. In various instances, a fuel provider may input other information along with the bid. The information may include locations of the fuel filling stations operated by the fuel provider, ancillary services and amenities that are provided by the fuel provider at the fuel filling stations, hours of operations, reputation reviews or ratings of the fuel provider, and/or other relevant information. In some embodiments, a bid may be submitted by a conglomerate of multiple fuel providers rather than a single provider. For example, multiple fuel providers may decide to cooperatively band together to make their bid more attractive in terms of competitive pricing, a greater number and/or locations of available fuel filling stations, more hours of operation, and/or other factors.

In block 808, the fuel clearinghouse service 102 may communicate the at least one bid to the fuel provider. The bid may be presented via a portal, or communicated through various electronic information distribution channels (e.g., email, text, automatic voice mails, etc.) that are capable of reaching the demand consumer.

In block 810, the fuel clearinghouse service 102 may receive an indication that the fuel provider has accepted a bid from an additional fuel provider to fulfill the excess demand by paying a particular fee. In various embodiments, the fuel provider may use the auction function built into the portal of the service to accept the bid. For example, the fuel provider may be motivated to accept a bid that offers the most competitive (e.g., highest) fee payment for the excess demand. However, the fuel provider may also be influenced by other factors, such as locations of the fuel stations, hours of operations, provider reputation, etc. to select a particular bid. In some instances, the accepted bid may be from a conglomerate of fuel providers rather than a single provider.

In block 812, the fuel clearinghouse service 102 may generate a contract for the additional fuel provider to fulfill the excess demand in exchange for paying the particular fee to the fuel provider. In some instances, the contract may state that the additional fuel provider is to pay the fee directly to the fuel provider. Alternatively, the total fees paid by the additional fuel provider is equal to the particular fee and applicable governmental charges, in which the governmental charges must be forwarded by the fuel provider to the responsible governmental entity. In various embodiments, the contract may be generated based on the information supplied by the additional fuel provider and the fuel provider at the time of registration. The contract may contain payment terms and conditions that ensure the additional fuel provider pays the fuel provider.

In block 814, the fuel clearinghouse service 102 may use the portal to present the contract to the fuel provider and the additional fuel provider. In various embodiments, the contract may be presented as an electronic document, and each party may provide an electronic signature and/or acknowledgment via the portal to indicate that the party agrees to the contract.

In block 816, the fuel clearinghouse service 102 may receive a notification that the fuel provider and the additional fuel provider have mutually accepted the contract. For example, each party may accept the contract by providing a legally enforceable electronic signature and/or acknowledgment. Following the provision of the electronic signature and/or acknowledgment by all the parties, the portal may send the notification to the service. In some instances, the notification may trigger the fuel clearinghouse service 102 to automatically deduct from a financial account of the fuel provider and/or the additional fuel provider a flat service fee or a service fee that is a percentage of the fee paid by the additional fuel provider. However, in other instances, the fuel clearinghouse service 102 may be configured to deduct a fee following actual distribution of the fuel to the vehicles of the demand consumer. In some instances, the terms and conditions of the contract may stipulate that the payment of fee owed to the fuel provider is entirely handled by the fuel provider and the additional fuel provider without the involvement of the fuel clearinghouse service operator. However, in other instances, the operator of the fuel clearinghouse service 102 may act as an escrow agent, such that the additional fuel provider pays the operator of the service for the excess demand, and the operator of the service then delivers one or more payments to the fuel provider after the entire quantity of fuel or each predetermined portion of the quantity of fuel has been distributed by the additional fuel provider to the vehicles of the demand consumer.

In block 818, the fuel clearinghouse service 102 may distribute fuel codes that are redeemable for the quantity of fuel from the additional fuel provider to the demand consumer. In various embodiments, the fuel codes may be in the form of points, vouchers, or other electronic credits, in which each fuel code is redeemable for a corresponding amount of fuel from one or more fuel filling stations of the particular fuel provider. In some embodiments, the service may distribute the fuel codes via email, text, as credit on a reloadable electronic or magnetic value card, or credit on a reloadable electronic wallet application on a mobile device (e.g., a smartphone), credit stored in a vehicle computer, or so forth, to the demand consumer or authorized agents of the demand consumer.

In block 820, the fuel clearinghouse service 102 may receive a notification that one or more fuel codes have been redeemed for a corresponding quantity of fuel. In some instances, the notification may be an automatic real-time or near real-time notification that is sent by an electronic reader (e.g., a magnetic card reader, an RFID reader, a code reader, a chip reader, etc.) that is installed at the fuel dispensers of the additional fuel provider. Each of the installed electronic reader may be own and/or maintained by the operator of the fuel clearinghouse service or by the additional fuel provider. In other instances, the notification may be a periodic notification (e.g., a daily report) that is submitted by the additional fuel provider to the fuel clearinghouse service 102 via the portal.

In block 822, the fuel clearinghouse service 102 may invalidate the one or more redeemed fuel codes from being used for additional redemption of fuel. In instances in which the fuel clearinghouse service 102 is configured to deduct a fee from the fuel provider or additional fuel provider following the delivery of the fuel, the redemption of the fuel codes may trigger the service to deduct a corresponding fee from the financial account of the one or more fuel providers.

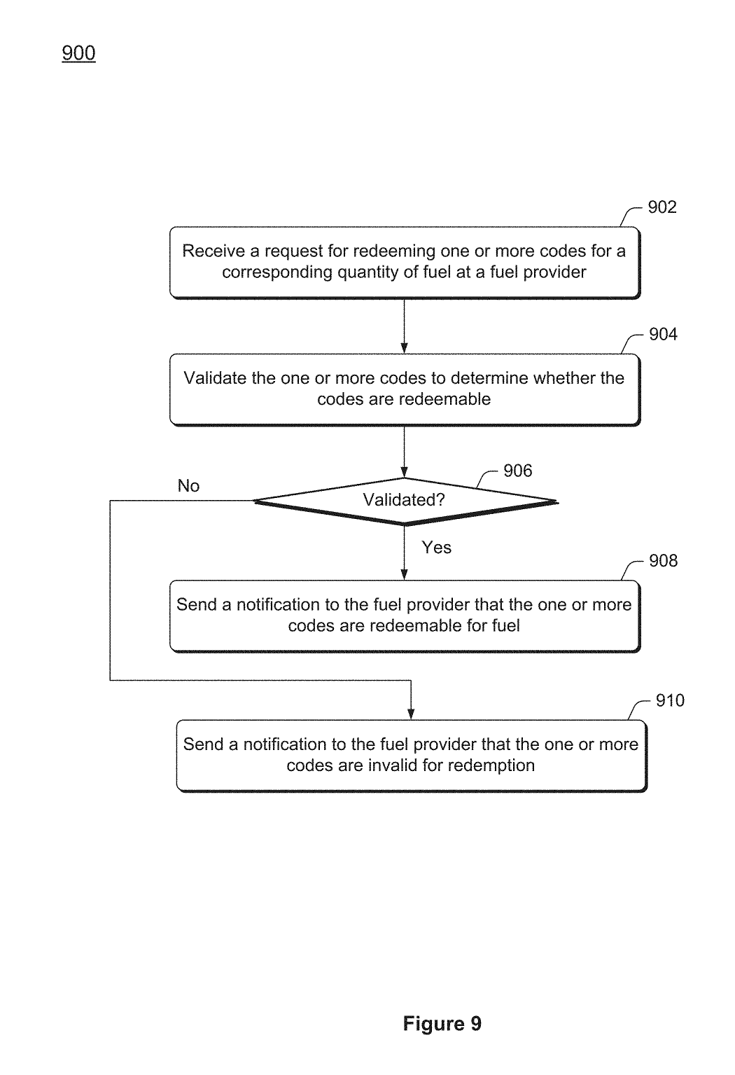

FIG. 9 is a flow chart of an example process 900 for fuel clearinghouse service to validate the redemption of issues fuel codes by a demand consumer for fuel at a fuel provider. In block 902, the fuel clearinghouse service 102 may receive a request for redeeming one or more fuel codes for a corresponding quantity of fuel at a fuel provider. The request may be received by the service via a network (e.g., Internet), and the request may be a machine-to-machine query message that originates from electronic reader software that is installed at a fuel dispenser of the fuel provider. The request may be initiated when an attempted is made by a consumer to pay for a quantity of fuel using the one or more fuel codes.

In block 902, the fuel clearinghouse service 102 may validate the one or more fuel codes to determine whether the fuel codes are redeemable for the quantity of fuel. The validation may be performed based on multiple factors. These factors may include whether the fuel codes have been marked as invalid for having been previously redeemed, invalid for having been reported as lost, stolen, or otherwise compromised due to illegal activity, invalid as having expired, invalid due to lack of payment for fuel by a purchaser within a predetermined time limit, invalid due to the breach or cancellation of an underlying contract, and/or so forth.

In decision block 906, if the fuel clearinghouse service 102 determines that the one or more fuel codes are valid (“yes” in decision block 906), the process 900 may proceed to block 908. In block 908, the fuel clearinghouse service 102 may send a notification to the fuel provider that the one or more fuel codes are redeemable for fuel. In various embodiments, the notification may be a machine-to-machine response message to the electronic reader software installed at the fuel dispenser of the fuel provider. The notification may trigger the electronic reader software to approve the disbursement of an equivalent fuel quantity from the fuel dispenser.

However, if the fuel clearinghouse service 102 determines that the one or more fuel codes are invalid (“no” in decision block 906), the process 900 may proceed to block 910. In block 910, the fuel clearinghouse service 102 may send a notification to the fuel provider that the one or more fuel codes are invalid for redemption. In various embodiments, the notification may be a machine-to-machine response message to the electronic reader software installed at the fuel dispenser of the fuel provider. The notification may trigger the electronic reader software to refuse the disbursement of fuel from the fuel dispenser.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A system to provide vehicle fuel as a service, comprising:
a processor configured to execute computer-readable instructions;
a memory communicatively coupled to the process and configured to store computer-readable instructions;
a post database configured to store fuel supply posts and demand posts, the supply and demand posts including post information comprised of at least of a fuel amount, a fuel price and a time window;
a supply posting software module resident in the memory configured to receive fuel supply posts and to store the received fuel supply posts in the post database, and configured to display selected demand posts;
a demand posting software module resident in the memory configured to receive demand posts and to store the received demand posts in the post database, and configured to display selected supply posts; and
a clearinghouse software module resident in the memory configured to retrieve an unfulfilled supply post from the post database, and to select at least one demand post based at least on some information of the unfulfilled supply post, and to send the selected supply post to the demand posting software module for display and to send the at least one demand post to the supply posting software module.

2. The system of claim 1, further comprising of an account/profile data store configured to store profiles comprised of preferences and restrictions of at least one demand consumer or fuel supplier, and wherein the clearinghouse software module is configured to select the at least one demand post based at least on one profile.

3. The system of claim 2, wherein the account/profile data store is configured to store profiles comprised of preferences and restrictions of at least one oil company, the oil company associated with at least one fuel supplier, and wherein the clearinghouse software module is configured to select the at least one demand post based at least on one profile of the oil company.

4. The system of claim 2, wherein the clearinghouse software module is configured to select a plurality of demand posts based at least on one profile, and to rank a plurality of demand posts based on a predetermined ordering criteria.

5. The system of claim 1, wherein a supply post or a demand post or both comprise of a fulfillment preference, and wherein the clearinghouse software module is configured to select the at least one demand post based at least on a profile of an oil company.

6. The system of claim 5, wherein the fulfillment preference is any one of:
time shifting;
demand shifting; or
fuel shifting.

7. The system of claim 1, wherein the information of the unfulfilled supply post information comprises a fulfillment criteria, the clearinghouse software module is comprised of a plurality of bidding submodules resident in the memory storing rules to select posts and the clearinghouse software, and wherein the clearinghouse software module is configured to selects a submodule corresponding to a fulfillment criteria of a supply post, and the clearinghouse software module selects a demand post based at least on the rules stored in the selected bidding submodule.

8. The system of claim 7, wherein a bidding submodules are any one of a:
bidding submodule; and
reverse auction submodule.

9. The system of claim 1, comprising a contract generator module resident in the memory, configured to generate a contract based on a demand post and supply post, wherein the clearinghouse software module is configured to provide a demand post and the selected supply post to the contract generator module, and the contract generator module generates a contract based on a received demand post and a received supply post.

10. The system of claim 9 wherein the contract generator module sends the generated contract to the posts database and marks the received demand post and supply post as fulfilled.

11. The system of claim 10, comprising a usage monitoring module resident in the memory configured to receive fuel usage data from a plurality of client fuel mobile applications, to aggregate the received fuel usage data, to detect when fuel usage as exhausted a fulfilled supply post, and to notify at least one fuel provider when a fulfilled supply post is exhausted.

12. The system of claim 11, comprising a software portal resident in the memory configured to retrieve information from any one of posts from the posts database and fuel usage data from the usage monitoring module, and to display at least some of the retrieved information.

13. The system of claim 12, comprising a reporting module resident in the memory and accessible by the software portal configured to receive custom query information and wherein the retrieved information is based at least on the received custom query information.

14. The system of claim 12, wherein the software portal is configured only to display retrieved information in which a user using the software portal has been a party to.

15. A method to aggregate and analyze vehicle fuel usage data, comprising:
retrieving from a post database a plurality of fulfilled supply posts;
receiving at a usage monitor fuel usage data from a plurality of client mobile applications, the usage data indicating usage of fuel corresponding to the retrieved fulfilled supply posts;
retrieving from an accounts/profile database profile information regarding fulfillment preferences of at least one demand consumer corresponding to the fulfilled supply post;
performing machine learning analytics on data from the retrieved posts, the received usage data and the fulfillment preferences; and
generating usage patterns based at least on the performed machine learning analytics.

16. The method of claim 15, comprising generating a recommendation to change at least one fulfillment preference of at least one demand consumer based at least on the performed machine learning analytics.

17. The method of claim 15, wherein the accounts/profile database includes a profile storing at least one restriction for at least one oil company associated with at least one fuel provider, and wherein the performed machine learning analytics is based at least on the at least one restriction for the at least one oil company.

18. The method of claim 15, comprising detecting a likelihood of fraud or theft based at least on the performed machine learning analytics.

19. The method of claim 15 comprising: displaying a generated usage pattern on a software portal, wherein the software portal is configured only to display retrieved information in which a user using the software portal has been a party to.

20. A method to provide fuel as a service, comprising:
receiving a supplier registration by a fuel supplier, the supplier registration comprising a profile including preferences of the fuel supplier;
receiving a consumer registration by a demand consumer, the consumer registration including preferences of the demand consumer;
receiving an oil company registration by an oil company associated with the fuel supplier, the oil company registration comprising a profile including preferences of the oil company;
receiving a supply post from the fuel supplier, the supply post comprising at least a quantity of fuel and a fulfillment criterion;
receiving a demand post from the demand consumer, the demand post comprising at least a quantity of fuel;
selecting a bidding submodule based at least on the fulfillment criterion;
determining at the bidding submodule whether to fulfill the received demand post with the received supply post based at least on a combination of the fuel supplier, demand consumer, and oil company profiles;
generating a contract to fulfill the received demand post with the received supply post;
confirming a payment for the quantity of fuel in the supply post from the demand consumer; and
notifying the fuel supplier to release fuel corresponding to the supply post to the demand consumer.
